(19) United States
(12) Patent Application Publication
(10) Pub. No.: US 2025/0317485 A1
(43) Pub. Date: Oct. 9, 2025

(54) METAVERSE AVATAR NETWORK EXPOSURE

(71) Applicant: Nokia Technologies Oy, Espoo (FI)

(72) Inventors: Niranth AMOGH, Bangalore (IN); Saurabh KHARE, Bangalore (IN); Parthasarathi RAVINDRAN, Bangalore (IN)

(21) Appl. No.: 19/096,883

(22) Filed: Apr. 1, 2025

(30) Foreign Application Priority Data
Apr. 4, 2024 (IN) 202441027885

(51) Int. Cl. H04L 67/06; H04L 67/30

(52) U.S. Cl. CPC H04L 67/06; H04L 67/30

(57) ABSTRACT

An apparatus includes at least one processor; and at least one memory storing instructions that, when executed by the at least one processor, cause the apparatus at least to: transmit a request to perform at least one activity related to at least one avatar, and receive a response to the request to perform the at least one activity related to the at least one avatar that indicates whether performing the at least one activity related to the at least one avatar was a success or failure.

### TECHNICAL FIELD

The examples and non-limiting example embodiments relate generally to communications and, more particularly, to metaverse avatar network exposure.

### BACKGROUND

It is known for a communication device to gain access to a communication network via an access network node.

### SUMMARY

In accordance with an aspect, an apparatus includes at least one processor; and at least one memory storing instructions that, when executed by the at least one processor, cause the apparatus at least to: transmit a request to perform at least one activity related to at least one avatar; and receive a response to the request to perform the at least one activity related to the at least one avatar that indicates whether performing the at least one activity related to the at least one avatar was a success or failure.

In accordance with an aspect, an apparatus includes at least one processor; and at least one memory storing instructions that, when executed by the at least one processor, cause the apparatus at least to: receive a request to perform at least one activity related to at least one avatar; and transmit a response to the request to perform the at least one activity related to the at least one avatar that indicates whether performing the at least one activity related to the at least one avatar was a success or failure.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows creating an avatar profile and uploading the avatar object or avatar media.

FIG. 3 shows linking the avatar details with subscriber details.

FIG. 4 shows downloading the avatar object.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

### DETAILED DESCRIPTION OF EXAMPLE EMBODIMENTS

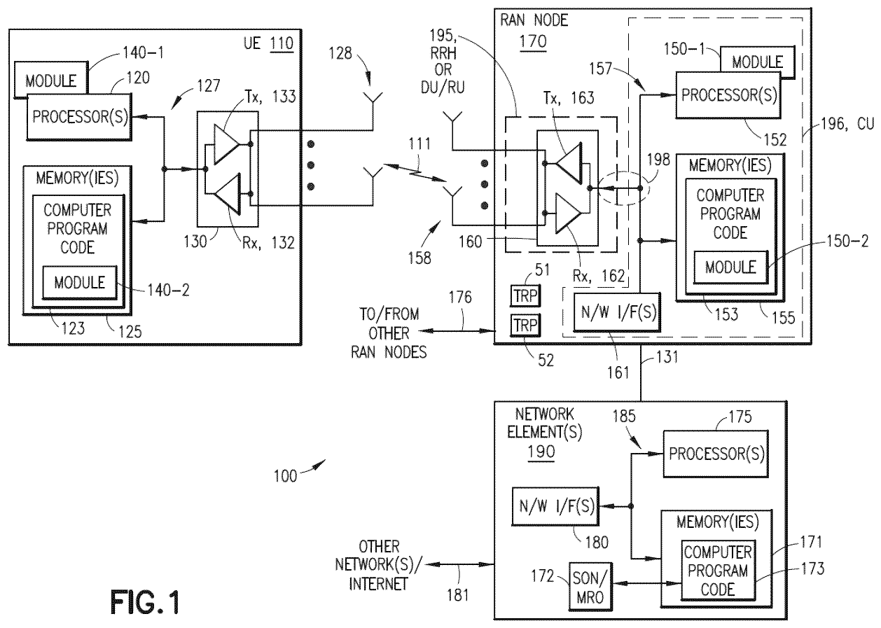

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Key issue #3 of TR 23.700-21 metaverse relates to the following:

Key issue #3: Digital avatars support
Description
In addition to new 5GS performance requirements, support for Metaverse services have
introduced new use cases and requirements related to optimal support for multi-user,
highly performant applications. These use cases led to new CN functionality supporting
richer digital representations of physical entities (e.g. user profiles in SA2, XR scene in
SA4)
As defined in 3GPP TS 22.156 [2], Avatars are digital representations of users
interacting with the metaverse and with other users. The application enabler layer can
enable creation, discovery, and management of avatar profiles for users to offload
applications and enable Core Network functionality across services and verticals.
NOTE 1: The work in SA6 focuses on providing enablement service to application
specific Avatar profile and if available, can leverage the work done in SA2 and SA4.
Editor's note: How application specific Avatar profile can be linked to user subscription
is FFS and depends on SA2 work.
Therefore, solutions addressing this key issue may also leverage work from SA2 and
SA4 on user profiles and digital assets.
The following use cases can be considered for study of value-added features:
A user provides configuration (or preferences) indicating which metaverse
application services can access the avatar information when the user performs transition
between metaverse services, to make sure that consistency and continuity of their digital
representation is maintained.
SA6 can maintain a list of applications allowed to use the avatar (similar to
allowed MNO list for federation in EDGEAPP)
A User creates multiple avatars and indicates his/her preferences such as: use of
specific avatars based on location, use of audio-only service only when experiencing
low bandwidth.
SA6 can maintain user's choices and: provide avatar information to different
application servers based on the location of the user, reject requests for avatar-based
communication in poor network conditions, etc.
Open issues
This key issue will study:
What SA6-defined information is required to expose the SA2-defined, SA4-
defined and SA3-defined avatar information to support allowed application
configuration, location-based avatar contextual information?
Whether and how application enablement layer manages and exposes information
about digital avatars to the consumers (i.e. application clients and servers) or across
verticals?

In summary, a first application function should be allowed to store/create the avatar details in the 5G system, modify/delete the avatar details in the 5G system, and associate the avatar with subscriber in the 5G system. Then a second application function should be allowed to: discover the avatar details in the 5G system associated to a subscriber, and download the avatar details from the 5G system associated to a subscriber. However, nothing is defined in the standards.

The metaverse application enabling layer acts as a glue between 5GC and the application consumer.

Digital asset container (DAC) shall exist inside the 5GS or in the AF of the operator. The AF of the operator can also be called the DAC SEAL server or DAC AF server.

5GC or the AF shall provide following APIs to Metaverse Application Server or Metaverse application supported UE:

### 1 Create the Avatar Profile

### 1.1 Create the Avatar Profile Request

This request is sent by AS or UE to the 5GC/AF to create the avatar profile. This request contains an avatar ID, avatar properties, and avatar usage policies. The avatar ID is the avatar identifier. Avatar Properties includes avatar name and Maximum size. Avatar usage policies include multiple policies such as Policy 1, Policy 2, to Policy N for integer N. As an example, Policy 1 includes Application Server identities: Netflix| Amazon| all, and Usage criterion: Location X. Policy 2 includes Application Server identities: WhatsApp | all, and Usage criterion: Time range list, Date-range list, Day(s) of the week, Week, Month(s), Year(s). Policy N may include similar information.

### 1.2 Create the Avatar Profile Response

This response contains success or failure. In case of successful, the 5GC/AF shall create the avatar Id and provide it to the AS or UE. In case of the failure, the reason for the failure will be provided by 5GC/AF.

### 1.3 Procedure

This request is sent by AS or UE to create the avatar profile. Based on the request, the 5GC shall create the avatar profile and allocate the new avatar Id.

2 Upload/store the avatar

### 2.1 Upload the Avatar Request

This request is sent by AS or UE to the 5GC/AF to store the avatar. This request contains: Avatar ID: avatar identifier, Avatar Object/Media information: Media file or URI of where the media resides.

### 2.2 Upload the Avatar Response

This response from 5GC/AF to AS or UE contains success or failure.

### 2.3 Procedure

This request is sent by AS or UE to the 5GC/AF to upload the avatar file against the avatar Id. If avatar id is not available, then error is returned. If avatar file is not in correct format, error is returned.

### 3 Modify the Avatar Profile

### 3.1 Modify the Avatar Profile Request

This request is sent by AS or UE to the 5GC/AF to modify the avatar profile. This request contains: Avatar ID: avatar identifier, Avatar Object/Media information or Avatar properties

### 3.2 Modify the Avatar Profile Response

This response from 5GC/AF to the AS or UE contains success or failure.

### 3.3 Procedure

This request is sent by AS or UE to the 5GC/AF to modify the avatar profile. If avatar id is not available, then error is returned.

### 4 Linking the Avatar

### 4.1 Linking the Avatar Request

This request is sent by AS or UE to the 5GC/AF to link the avatar information with the subscriber. This request contains: Avatar ID: avatar identifier, and Subscriber Id: GPSI/External Id

### 4.2 Linking the Avatar Response

This response from 5GC/AF to the AS or UE contains success or failure.

### 4.3 Procedure

This request is sent by AS or UE to the 5GC/AF to link the avatar with the subscriber. If avatar id or subscriber Id is not available, then error is returned. Authorization (e.g. User consent) is obtained from the subscriber to be linked to the Avatar information. If the UE or AS is not authorized to perform the linking, then error is returned. If linking is successful the avatar ID and the linked subscriber information can be stored in 5GC/AF.

### 5 Download the Avatar.

### 5.1 Download the Avatar Request.

This request is sent by AS or UE to the 5GC/AF to download the avatar. This request contains: Avatar ID: avatar identifier or Subscriber Id, and Additional Filter/adaptation: Server: Amazon/Netflix, Media adaptation related to Server: compression, resolution of media, Media adaptation related to UE: network QoS situation (QOS X: compression, resolution of media, QOS Y: compression, resolution of media, . . . ).

### 5.2 Download the Avatar Response.

This response from 5GC/AF to the AS or UE contains success or failure. In case of success, all the avatar objects/media information are returned in the response message

### 5.3 Procedure

This request is sent by AS or UE to download the avatar information related to the avatar Id or subscriber id. If subscriber id is linked to multiple avatar, then multiple avatar objects/media information are returned. If an additional filter is available in the request, the avatar objects are filtered accordingly. If avatar id/subscriber Id is not available, then error is returned. If AS or UE is not authorized to perform this operation, then error is returned.

### 6 Delete the Avatar

### 6.1 Delete Avatar Request.

This request is sent by AS or UE to the 5GC/AF to delete the avatar. This request contains: Avatar IDs: the list of avatar identifier (one or more), and Subscriber Id: GPSI or external identifier

### 6.2 Delete the Avatar Response.

This response from 5GC/AF to the AS or UE contains success or failure. In case of success, the avatar IDs which are deleted are returned.

### 6.3 Procedure

This request is sent by AS or UE to the 5GC/AF to delete the avatar details against the avatar Id or subscriber id. If subscriber id contains multiple avatars, then multiple avatar objects are deleted. In case the AS or UE is not authorized to delete the avatar information, the error is returned by the 5GC/AF. If the messages in clauses 5.2 and 5.5 for transfer of media for Upload and Download of Avatar object/media respectively cannot be performed then a specific media transfer session (e.g. SFTP) is established between 5GC/AF and AS or UE to enable transfer of the avatar object/media.

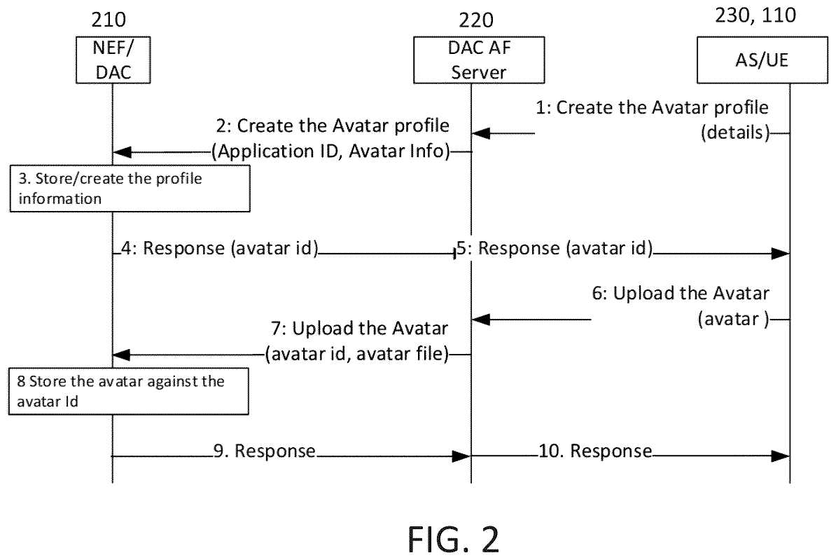

FIG. 2 an example of creating the avatar profile and uploading the avatar object and/or object media. FIG. 2 shows an example signaling exchange between NEF/DAC (210), DAC AF server 220, and AS 230 or UE 110.

Steps of FIG. 2 include (1-10):
1. AS/UE sends the “create the avatar profile” request to DAC AF Server with the details as specified in clause 1.1
2. The DAC AF server checks the authorization of the AS/UE to perform the operation. If successful, then DAC AF server identifies whether location of the storage of avatar profile information is available with 5GC (NEF/DAC). If the location of the avatar profile information is available with 5GC (NEF/DAC), then DAC AF server forwards the “create the avatar profile” request to the 5GC (NEF/DAC).
3. If location of the storage of avatar profile information is 5GC then 5GC stores the avatar profile else the storage of avatar profile information is performed at DAC AF server.
4. The 5GC sends a response to DAC AF server indicating success or failure of the operation. If success, the DAC AF server registers the location of the storage related to the avatar ID.
5. The DAC AF server sends a response to the AS or UE indicating success or failure of the operation with the details as specified in clause 1.2.
6. After successful creation of avatar information, the AS or UE sends the “Upload the avatar” request to the DAC AF server with the details as specified in clause 2.1.
7. The DAC AF server checks the authorization of the AS/UE to perform the operation. If successful, the DAC AF server determines the location of the storage of the avatar ID. If the location of the storage of avatar ID is 5GC, then the DAC AF server forwards the “upload the avatar” request to the 5GC.
8. If location of the storage for the avatar ID is 5GC, then 5GC performs the storage of avatar object/media information else the storage of the avatar object/media information is performed at DAC AF server.
9. The 5GC sends a response to DAC AF server indicating success or failure of the operation.
10. The DAC AF server sends a response to the AS or UE indicating success or failure of the operation with the details as specified in clause 2.2.

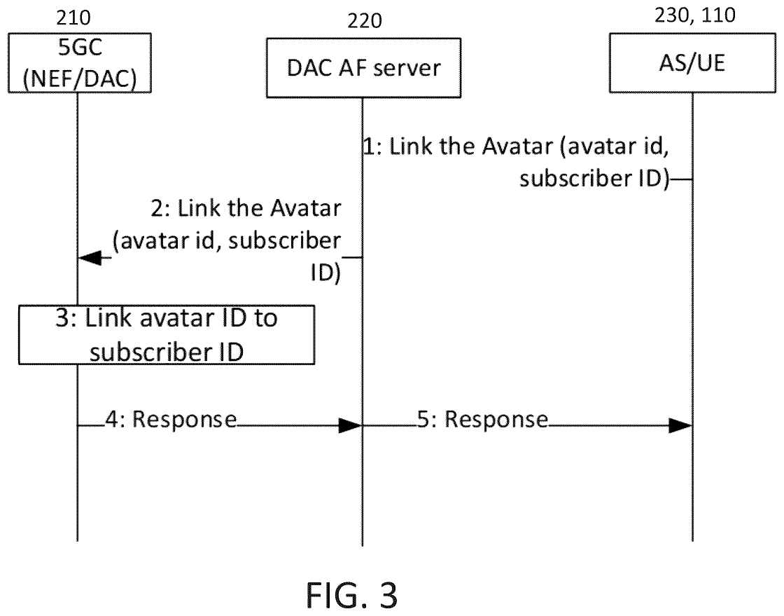

FIG. 3 shows an example of linking the avatar, including linking the avatar details with subscriber details. FIG. 3 shows an example signaling exchange between 5GC NEF/DAC (210), DAC AF server 220, and AS 230 or UE 110. Steps of FIG. 3 include (1-5):
1. AS/UE sends a “Link the avatar” request to the DAC AF server with the details as specified in clause 4.1.
2. The DAC AF server checks the authorization of the AS/UE to perform the operation. If successful, the DAC AF server determines the location of the storage of the avatar ID. If the location of the storage of avatar ID is 5GC, then the DAC AF server forwards the “link the avatar” request to the 5GC.
3. If location of the storage for the avatar ID is 5GC, then 5GC checks for the authorization (e.g user consent) of the subscriber (as per the subscriber ID) for linking the avatar with the subscriber. If authorized, the 5GC links the avatar ID with the subscriber ID and stores the related information. If the location of the avatar ID is DAC AF server, then the step 3 processing is performed by DAC AF server.
4. The 5GC sends a response to DAC AF server indicating success or failure of the operation.
5. The DAC AF server sends a response to the AS or UE indicating success or failure of the operation with the details as specified in clause 4.2.

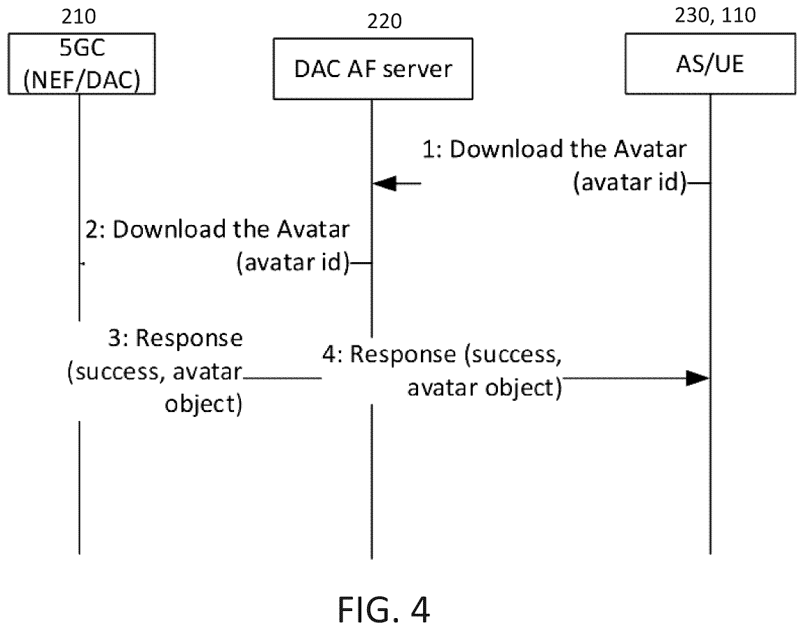

FIG. 4 shows an example of downloading the avatar object. FIG. 3 shows an example signaling exchange between 5GC NEF/DAC (210), DAC AF server 220, and AS 230 or UE 110. Steps of FIG. 4 include (1-4):
1. AS/UE sends a “Download the avatar profile” request to the DAC AF server with the details as specified in clause 5.1.
2. The DAC AF server checks the authorization of the AS/UE to perform the operation. If successful, the DAC AF server determines the location of the storage of the avatar ID. If the location of the storage of avatar ID is 5GC, then the DAC AF server forwards the “download the avatar profile” request to the 5GC.
3. If location of the storage for the avatar ID is 5GC, then 5GC sends a response to DAC AF server indicating success or failure of the operation. If success, it includes the avatar object/media information. If location of the storage for avatar ID is DAC AF server, the step 3 processing is performed by DAC AF server.
4. The DAC AF server receives the avatar object/media information from 5GC. The DAC AF server performs the media adaptation as per the additional filters/adaptation information in the request on the avatar object/media. The adapted avatar media/object is used in the further response to AS or UE. The DAC AF server sends a response to the AS or UE indicating success or failure of the operation with the details as specified in clause 5.2.

The examples described herein may be applicable to 3GPP Rel-19.

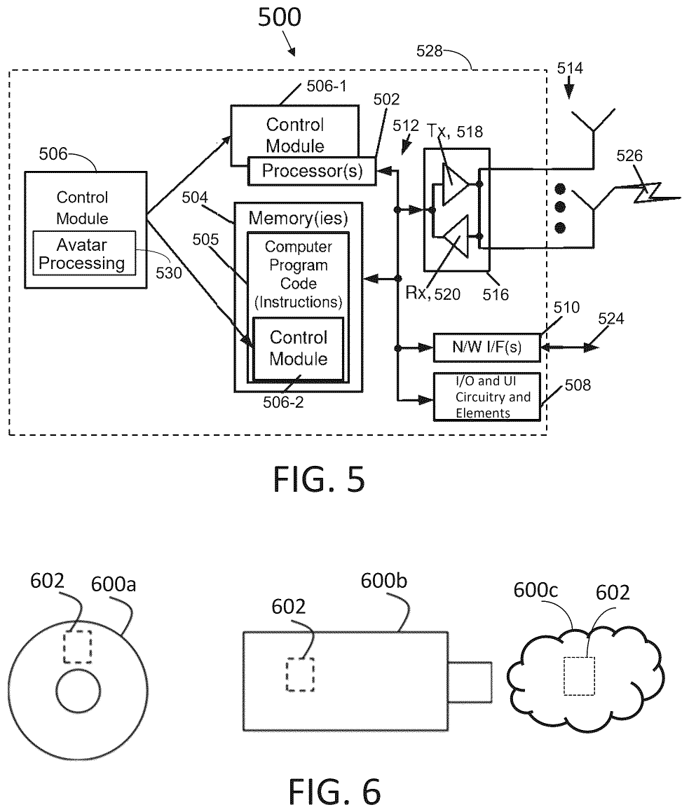

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein. The one or more memories 504 may include a non-transitory memory, a transitory memory, a volatile memory (e.g. RAM), or a non-volatile memory (e.g. ROM).

Avatar processing 530 implements the examples described herein related to metaverse avatar network exposure.

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 131 and/or 176 from FIG. 1. The link(s) 131 and/or 176 from FIG. 1 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de) modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 110, RAN node 170 (e.g. gNB), or network element(s) 190 (e.g. LMF 190). Thus, processor 502 may correspond to processor(s) 120, processor(s) 152 and/or processor(s) 175, memory 504 may correspond to one or more memories 125, one or more memories 155 and/or one or more memories 171, computer program code 505 may correspond to computer program code 123, computer program code 153, and/or computer program code 173, control module 506 may correspond to module 140-1, module 140-2, module 150-1, and/or module 150-2, and communication I/F(s) 510 and/or transceiver 516 may correspond to transceiver 130, antenna(s) 128, transceiver 160, antenna(s) 158, N/W I/F(s) 161, and/or N/W I/F(s) 180. Alternatively, apparatus 500 and its elements may not correspond to either of UE 110, RAN node 170, or network element(s) 190 and their respective elements, as apparatus 500 may be part of a self-organizing/optimizing network (SON) node or other node, such as a node in a cloud.

Apparatus 500 may correspond to any of the other apparatuses described herein, including 5GC NEF/DAC (210), DAC AF server 220, or AS 230.

The apparatus 500 may also be distributed throughout the network (e.g. 100) including within and between apparatus 500 and any network element (such as a network control element (NCE) 190 and/or the RAN node 170 and/or UE 110).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505, or computer program code (e.g. instructions) 505, including control 506 may include functional, scripting, or procedural code. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein. Instructions and/or parameters 602 may represent a non-transitory computer readable medium.

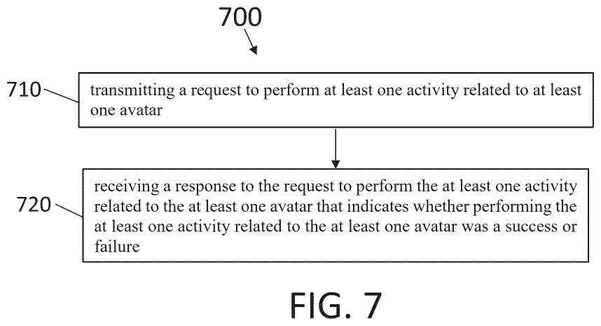

FIG. 7 is an example method 700 based on the examples described herein. At 710, the method includes transmitting a request to perform at least one activity related to at least one avatar. At 720, the method includes receiving a response to the request to perform the at least one activity related to the at least one avatar that indicates whether performing the at least one activity related to the at least one avatar was a success or failure. Method 700 may be performed with UE 110, AS 230, or apparatus 500.

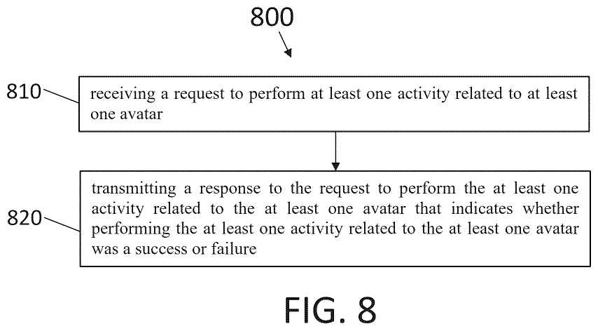

FIG. 8 is an example method 800 based on the examples described herein. At 810, the method includes receiving a request to perform at least one activity related to at least one avatar. At 820, the method includes transmitting a response to the request to perform the at least one activity related to the at least one avatar that indicates whether performing the at least one activity related to the at least one avatar was a success or failure. Method 800 may be performed with one or more network elements 190, DAC AF Server 220, NEF/DAC 210, or apparatus 500.

The following examples are provided and described herein.

Example 1. An apparatus including: at least one processor; and at least one memory storing instructions that, when executed by the at least one processor, cause the apparatus at least to: transmit a request to perform at least one activity related to at least one avatar; and receive a response to the request to perform the at least one activity related to the at least one avatar that indicates whether performing the at least one activity related to the at least one avatar was a success or failure.

Example 2. The apparatus of example 1, wherein the instructions, when executed by the at least one processor, cause the apparatus at least to: transmit a request to create at least one avatar profile for the at least one avatar, wherein the at least one activity comprises creating the at least one avatar profile for the at least one avatar; and receive a response to the request to create the at least one avatar profile for the at least one avatar that indicates whether creating the at least one avatar profile for the at least one avatar was a success or failure; wherein when creating the at least one avatar profile for the at least one avatar was a success, the response includes at least one avatar identifier; wherein when creating the at least one avatar profile for the at least one avatar was a failure, the response to the request to create the at least one avatar profile for the at least one avatar includes a reason for the failure.

Example 3. The apparatus of example 2, wherein the request to create the at least one avatar profile comprises at least one or more of: the at least one avatar identifier, or avatar properties including at least one avatar name and a maximum size of the at least one avatar, or usage policies for the at least one avatar, wherein a usage policy for the at least one avatar comprises an application sever identity and usage criteria, wherein the usage criteria comprise a location, time, or date applicable to the at least one avatar.

Example 4. The apparatus of any of examples 1 to 3, wherein the instructions, when executed by the at least one processor, cause the apparatus at least to: transmit a request to upload the at least one avatar, wherein the at least one activity comprises uploading the at least one avatar; wherein the request to upload the at least one avatar comprises at least one or more of: at least one avatar identifier, or avatar object or media information comprising a media file or a uniform resource identifier where media associated with the at least one avatar resides; and receive a response to the request to upload the at least one avatar that indicates whether uploading the at least one avatar was a success or failure.

Example 5. The apparatus of any of examples 1 to 4, wherein the instructions, when executed by the at least one processor, cause the apparatus at least to: transmit a request to link the at least one avatar to link avatar information with at least one subscriber, wherein the request to link the at least one avatar comprises at least one avatar identifier and at least one subscriber identifier, wherein the at least one activity comprises linking the at least one avatar; and receive a response to the request to link the at least one avatar that indicates whether linking the at least one avatar was a success or failure.

Example 6. The apparatus of example 5, wherein: the response to the request to link the at least one avatar indicates that linking the at least one avatar was a failure, when the at least one avatar identifier or the at least one subscriber identifier is unavailable; and the response to the request to link the at least one avatar indicates that linking the at least one avatar was a failure, when a user equipment or application server is not authorized for the linking of the at least one avatar.

Example 7. The apparatus of any of examples 1 to 6, wherein the instructions, when executed by the at least one processor, cause the apparatus at least to: transmit a request to download the at least one avatar, wherein the at least one activity comprises downloading the at least one avatar; wherein the request to download the at least one avatar comprises at least one avatar identifier, at least one subscriber identifier, and filter or adaptation information; wherein the filter or adaptation information comprises at least one or more of: a server, media adaptation information related to the server comprising compression or resolution of media, or media adaptation information related to a user equipment comprising network quality of service information related to compression or resolution of media; and receive a response to the request to download the at least one avatar that indicates whether downloading the at least one avatar was a success or failure; and receive information related to the at least one avatar, when downloading the at least one avatar was a success, wherein the information related to the at least one avatar comprises adapted avatar information that is adapted based on the filter or adaptation information.

Example 8. The apparatus of example 7, wherein the instructions, when executed by the at least one processor, cause the apparatus at least to: receive information related to multiple avatars, when multiple avatars are linked to the at least one subscriber identifier.

Example 9. The apparatus of any of examples 7 to 8, wherein: the response to the request to download the at least one avatar indicates that downloading the at least one avatar was a failure, when the at least one avatar identifier or the at least one subscriber identifier is unavailable; and the response to the request to download the at least one avatar indicates that downloading the at least one avatar was a failure, when a user equipment or application server is not authorized for the downloading of the avatar.

Example 10. The apparatus of any of examples 1 to 9, wherein the instructions, when executed by the at least one processor, cause the apparatus at least to: transmit a request to modify the at least one avatar, wherein the at least one activity comprises modifying the at least one avatar; wherein the request to modify the at least one avatar comprises at least one avatar identifier, information related to the at least one avatar, and avatar properties; and receive a response to the request to modify the at least one avatar; wherein the response to the request to modify the at least one avatar indicates whether modifying the at least one avatar was a success or a failure; wherein the response to the request to modify the at least one avatar indicates that modifying the at least avatar is a failure when the at least one avatar identifier is unavailable.

Example 11. The apparatus of any of examples 1 to 10, wherein the instructions, when executed by the at least one processor, cause the apparatus at least to: transmit a request to delete the at least one avatar, wherein the at least one activity comprises deleting the at least one avatar; wherein the request to delete the at least one avatar comprises at least one of: a list of at least one avatar identifier, or at least one subscriber identifier; and receive a response to the request to delete the at least one avatar; wherein the response to the request to delete the at least one avatar indicates whether deleting the at least one avatar was a success or a failure; wherein the response to the request to delete the at least one avatar includes the at least one avatar identifier that is deleted when the response to the request to delete the at least one avatar indicates success; wherein the response to the request to delete the at least one avatar indicates that deleting the at least one avatar is a failure, when the apparatus is not authorized to delete the at least one avatar.

Example 12. The apparatus of example 11, wherein when the list of the at least one avatar identifier included in the request to delete the at least one avatar comprises multiple avatar identifiers, multiple avatars associated with the multiple avatar identifiers are deleted.

Example 13. The apparatus of any of examples 11 to 12, wherein when the request to delete the at least one avatar comprises the at least one subscriber identifier without the list of the at least one avatar identifier, all avatars associated with the at least one subscriber identifier are deleted.

Example 14. The apparatus of any of examples 1 to 13, wherein the instructions, when executed by the at least one processor, cause the apparatus at least to: establish a secure file transfer protocol session or other data transfer protocol for transferring information related to the at least one avatar, when uploading or downloading the information related to the at least one avatar is unavailable otherwise.

Example 15. The apparatus of any of examples 1 to 14, wherein the apparatus comprises an application server or a user equipment.

Example 16. An apparatus including: at least one processor; and at least one memory storing instructions that, when executed by the at least one processor, cause the apparatus at least to: receive a request to perform at least one activity related to at least one avatar; and transmit a response to the request to perform the at least one activity related to the at least one avatar that indicates whether performing the at least one activity related to the at least one avatar was a success or failure.

Example 17. The apparatus of example 16, wherein the instructions, when executed by the at least one processor, cause the apparatus at least to: receive a request to create at least one avatar profile for the at least one avatar, wherein the at least one activity comprises creating the at least one avatar profile for the at least one avatar; and transmit a response to the request to create the at least one avatar profile for the at least one avatar that indicates whether creating the at least one avatar profile for the at least one avatar was a success or failure; wherein when creating the at least one avatar profile for the at least one avatar was a success, the response includes at least one avatar identifier; wherein when creating the at least one avatar profile for the at least one avatar was a failure, the response to the request to create the at least one avatar profile for the avatar includes a reason for the failure.

Example 18. The apparatus of example 17, wherein the request to create the at least one avatar profile comprises at least one or more of: the at least one avatar identifier, or avatar properties including at least one avatar name and a maximum size of the at least one avatar, or usage policies for the at least one avatar, wherein a usage policy for the at least one avatar comprises an application sever identity and usage criteria, wherein the usage criteria comprise a location, time, or date applicable to the at least one avatar.

Example 19. The apparatus of any of examples 17 to 18, wherein the instructions, when executed by the at least one processor, cause the apparatus at least to: determine whether an application server or user equipment from which the request to create the at least one avatar profile was received is authorized for the at least one avatar profile; determine whether a location of storage of information associated with the at least one avatar profile is available in a network entity, in response to determining that the application server or user equipment from which the request to create the at least one avatar profile was received is authorized for the at least one avatar profile; and forward the request to create the at least one avatar profile to the network entity, in response to the location of storage of information associated with the at least one avatar profile being available in the network entity.

Example 20. The apparatus of example 19, wherein the instructions, when executed by the at least one processor, cause the apparatus at least to: receive, from the network entity, a response to the request to create the at least one avatar profile for the at least one avatar that indicates whether creating the at least one avatar profile for the at least one avatar was a success or failure; wherein when creating the at least one avatar profile for the at least one avatar was a success, the response to the request to create the at least one avatar received from the network entity includes the at least one avatar identifier; and register a location of storage related to the at least one avatar profile or the at least one avatar identifier, in response to the response to the request to create the at least one avatar profile for the at least one avatar received from the network entity indicating that creating the at least one avatar profile was a success.

Example 21. The apparatus of any of examples 16 to 20, wherein the instructions, when executed by the at least one processor, cause the apparatus at least to: receive a request to upload the at least one avatar, wherein the at least one activity comprises uploading the at least one avatar; wherein the request to upload the at least one avatar comprises at least one or more of: at least one avatar identifier, or avatar object or media information comprising a media file or a uniform resource identifier where media associated with the at least one avatar resides; and transmit a response to the request to upload the at least one avatar that indicates whether uploading the at least one avatar was a success or failure.

Example 22. The apparatus of example 21, wherein the instructions, when executed by the at least one processor, cause the apparatus at least to: determine whether an application server or user equipment from which the request to upload the at least one avatar was received is authorized for uploading of the at least one avatar; determine a location of storage of the at least one avatar identifier, in response to the application server or user equipment from which the request to upload the at least one avatar was received being authorized for uploading of the at least one avatar; and forward the request to upload the at least one avatar to a network entity, in response to the location of storage of the avatar identifier being with the network entity.

Example 23. The apparatus of example 22, wherein the instructions, when executed by the at least one processor, cause the apparatus at least to: receive, from the network entity, a response to the request to upload the at least one avatar, wherein the response to the request to upload the at least one avatar received from the network entity indicates whether uploading the at least one avatar was a success or failure.

Example 24. The apparatus of example 23, wherein: the response to the request to upload the at least one avatar received from the network entity indicates that uploading the at least one avatar was a failure, when at least one avatar file associated with the at least one avatar is not in a correct format; and the request to upload the at least one avatar forwarded to the network entity comprises the at least one avatar file.

Example 25. The apparatus of any of examples 23 to 24, wherein the response to the request to upload the at least one avatar received from the network entity indicates that uploading the at least one avatar was a failure, when the at least one avatar identifier is unavailable.

Example 26. The apparatus of any of examples 16 to 25, wherein the instructions, when executed by the at least one processor, cause the apparatus at least to: store information associated with at least one avatar profile for the at least one avatar, wherein the information associated with the at least one avatar profile comprises at least one or more of: at least one avatar identifier, or object or media information.

Example 27. The apparatus of any of examples 16 to 26, wherein the instructions, when executed by the at least one processor, cause the apparatus at least to: receive a request to link the at least one avatar to link avatar information with at least one subscriber, wherein the request to link the at least avatar comprises at least one avatar identifier and at least one subscriber identifier, wherein the at least one activity comprises linking the at least one avatar; and transmit a response to the request to link the at least one avatar that indicates whether linking the at least one avatar was a success or failure.

Example 28. The apparatus of example 27, wherein the instructions, when executed by the at least one processor, cause the apparatus at least to: determine whether an application server or user equipment from which the request to link the at least one avatar was received is authorized for avatar linking; determine a location of storage of the at least one avatar identifier, in response to the application server or user equipment from which the request to link the at least one avatar was received being authorized for avatar linking; and forward the request to link the at least one avatar to a network entity, in response to the location of storage of the avatar identifier being with the network entity.

Example 29. The apparatus of example 28, wherein the instructions, when executed by the at least one processor, cause the apparatus at least to: receive, from the network entity, a response to the request to link the at least one avatar indicating whether linking the at least one avatar was a success or failure; wherein the response to the request to link the at least one avatar received from the network entity indicates the linking the at least one avatar was a failure, when the at least one avatar identifier or the at least one subscriber identifier is unavailable; wherein the response to the request to link the at least one avatar received from the network entity indicates that linking the at least one avatar was a failure, when the user equipment or application server is not authorized for the linking of the at least one avatar.

Example 30. The apparatus of any of examples 27 to 29, wherein the instructions, when executed by the at least one processor, cause the apparatus at least to: determine whether there is authorization to link the at least one avatar with the at least one subscriber, based on the at least one subscriber identifier, when the apparatus stores the at least one avatar identifier; and link the at least one avatar identifier with the at least one subscriber identifier and store information related to the linking of the at least one avatar identifier with the at least one subscriber identifier, in response to there being authorization to link the at least one avatar with the at least one subscriber.

Example 31. The apparatus of any of examples 27 to 30, wherein: the response to the request to link the at least one avatar indicates that linking the at least one avatar was a failure, when the at least one avatar identifier or the at least one subscriber identifier is unavailable; and the response to the request to link the at least one avatar indicates that linking the at least one avatar was a failure, when a user equipment or application server is not authorized for the linking of the at least one avatar.

Example 32. The apparatus of any of examples 16 to 31, wherein the instructions, when executed by the at least one processor, cause the apparatus at least to: receive a request to download the at least one avatar, wherein the at least one activity comprises downloading the at least one avatar; wherein the request to download the at least one avatar comprises at least one avatar identifier, at least one subscriber identifier, and filter or adaptation information; wherein the filter or adaptation information comprises at least one or more of: a server, media adaptation information related to the server comprising compression or resolution of media, or media adaptation information related to a user equipment comprising network quality of service information related to compression or resolution of media; transmit a response to the request to download the at least one avatar that indicates whether downloading the at least one avatar was a success or failure; and transmit information related to the at least one avatar, when downloading the at least one avatar was a success.

Example 33. The apparatus of example 32, wherein: the response to the request to download the at least one avatar indicates that downloading the at least one avatar was a failure, when the at least one avatar identifier or the at least one subscriber identifier is unavailable; and the response to the request to download the at least one avatar indicates that downloading the at least one avatar was a failure, when a user equipment or application server is not authorized for the downloading of the at least one avatar.

Example 34. The apparatus of any of examples 32 to 33, wherein the instructions, when executed by the at least one processor, cause the apparatus at least to: determine whether an application server or user equipment from which the request to download the at least one avatar was received is authorized for downloading of the at least one avatar; determine a location of storage of the at least one avatar identifier, in response to the application server or user equipment from which the request to download the at least one avatar was received being authorized for downloading the at least one avatar; and forward the request to download the at least one avatar to a network entity, in response to the location of storage of the at least one avatar identifier being with the network entity.

Example 35. The apparatus of example 34, wherein the instructions, when executed by the at least one processor, cause the apparatus at least to: receive, from the network entity, a response to the request to download the at least one avatar that indicates whether downloading the at least one avatar was a success or a failure; wherein the response indicating whether downloading the at least one avatar was a success or failure received from the network entity comprises the information related to the at least one avatar, when downloading the at least one avatar is a success; and perform adaptation of the information related to the at least one avatar based on the filter or adaptation information to generate adapted avatar information, in response to downloading the at least one avatar being a success; wherein the information related to the at least one avatar transmitted when downloading the at least one avatar was a success comprises the adapted avatar information.

Example 36. The apparatus of example 35, wherein the information related to the at least one avatar that is transmitted or received from the network entity comprises information related to multiple avatars, when multiple avatars are linked to the at least one subscriber identifier.

Example 37. The apparatus of any of examples 35 to 36, wherein: the response to the request to download the at least one avatar received from the network entity indicates that downloading the at least one avatar was a failure, when the at least one avatar identifier or the at least one subscriber identifier is unavailable; and the response to the request to download the at least one avatar received from the network entity indicates that downloading the at least one avatar was a failure, when the user equipment or the application server is not authorized for the downloading of the at least one avatar.

Example 38. The apparatus of any of examples 16 to 37, wherein the instructions, when executed by the at least one processor, cause the apparatus at least to: receive a request to modify the at least one avatar, wherein the at least one activity comprising modifying the at least one avatar; wherein the request to modify the at least one avatar comprises at least one avatar identifier, information related to the at least one avatar, and avatar properties; and transmit a response to the request to modify the at least one avatar; wherein the response to the request to modify the at least one avatar indicates whether modifying the at least one avatar was a success or a failure; wherein the response to the request to modify the at least one avatar indicates failure when the at least one avatar identifier is unavailable.

Example 39. The apparatus of example 38, wherein the instructions, when executed by the at least one processor, cause the apparatus at least to: determine whether an application server or user equipment from which the request to modify the at least one avatar was received is authorized for modifying the at least one avatar; determine a location of storage of the at least one avatar identifier, in response to the application server or user equipment from which the request to modify the at least one avatar was received being authorized for modifying the at least one avatar; and forward the request to modify the at least one avatar to a network entity, in response to the location of storage of the at least one avatar identifier being with the network entity.

Example 40. The apparatus of example 39, wherein the instructions, when executed by the at least one processor, cause the apparatus at least to: receive, from the network entity, a response indicating whether modifying the at least one avatar was a success or a failure; wherein the response to the request to modify the at least one avatar received from the network entity indicates that modifying the at least one avatar is a failure when the at least one avatar identifier is unavailable.

Example 41. The apparatus of any of examples 16 to 40, wherein the instructions, when executed by the at least one processor, cause the apparatus at least to: receive a request to delete the at least one avatar, wherein the at least one activity comprises deleting the at least one avatar; wherein the request to delete the at least one avatar comprises at least one of: a list of at least one avatar identifier, or at least one subscriber identifier; and transmit a response to the request to delete the at least one avatar; wherein the response to the request to delete the at least one avatar indicates whether deleting the at least one avatar was a success or a failure; wherein the response to the request to delete the at least one avatar includes the at least one avatar identifier that is deleted when the response to the request to delete the at least one avatar indicates that deleting the at least one avatar is a success; wherein the response to the request to delete the at least one avatar indicates that deleting the at least one avatar is a failure, when an application server or user equipment from which the request to delete the at least one avatar was received is not authorized to delete the at least one avatar.

Example 42. The apparatus of example 41, wherein the instructions, when executed by the at least one processor, cause the apparatus at least to: determine whether the application server or user equipment from which the request to delete the at least one avatar was received is authorized for deleting the at least one avatar; determine a location of storage of the at least one avatar identifier, in response to the application server or user equipment from which the request to delete the at least one avatar was received being authorized for deleting the at least one avatar; and forward the request to delete the at least one avatar to a network entity, in response to the location of storage of the at least one avatar identifier being with the network entity.

Example 43. The apparatus of example 42, wherein the instructions, when executed by the at least one processor, cause the apparatus at least to: receive, from the network entity, a response indicating whether deleting the at least one avatar was a success or a failure; wherein the response to the request to delete the at least one avatar received from the network entity includes the at least one avatar identifier that is deleted, when the response to the request to delete the at least one avatar received from the network entity indicates that deleting the at least one avatar is a success.

Example 44. The apparatus of any of examples 41 to 43, wherein when the list of at least one avatar identifier included in the request to delete the at least one avatar comprises multiple avatar identifiers, multiple avatars associated with the multiple avatar identifiers are deleted.

Example 45. The apparatus of any of examples 41 to 44, wherein the instructions, when executed by the at least one processor, cause the apparatus at least to: delete multiple avatars associated with multiple avatar identifiers, in response to the list of at least one avatar identifier included in the request to delete the avatar comprising multiple avatar identifiers.

Example 46. The apparatus of any of examples 41 to 45, wherein when the request to delete the at least one avatar comprises the at least one subscriber identifier without the list of at least one avatar identifier, all avatars associated with the at least one subscriber identifier are deleted.

Example 47. The apparatus of any of examples 41 to 46, wherein the instructions, when executed by the at least one processor, cause the apparatus at least to: delete all avatars associated with the at least one subscriber identifier, in response to the request to delete the avatar comprising the at least one subscriber identifier without the list of at least one avatar identifier.

Example 48. The apparatus of any of examples 16 to 47, wherein the instructions, when executed by the at least one processor, cause the apparatus at least to: establish a secure file transfer protocol session or other data transfer protocol for transferring information related to the avatar, when uploading or downloading the information related to the avatar is unavailable otherwise.

Example 49. The apparatus of any of examples 16 to 48, wherein the instructions, when executed by the at least one processor, cause the apparatus at least to: create information associated with at least one avatar profile of the at least one avatar, wherein the information associated with the at least one avatar profile includes at least one avatar identifier.

Example 50. The apparatus of any of examples 16 to 49, wherein the instructions, when executed by the at least one processor, cause the apparatus at least to: receive a request to upload the at least one avatar, wherein the at least one activity comprises uploading the at least one avatar; determine whether the apparatus stores at least one avatar identifier associated with the at least one avatar; store object or media information associated with the at least one avatar, in response to the apparatus storing the at least one avatar identifier; and transmit a response to the request to upload the at least one avatar, wherein the response to the request to upload the avatar indicates whether uploading the avatar was a success or failure.

Example 51. The apparatus of example 50, wherein: the response to the request to upload the at least one avatar indicates that uploading the at least one avatar was a failure, when at least one avatar file associated with the at least one avatar is not in a correct format; and the request to upload the at least one avatar comprises the at least one avatar file.

Example 52. The apparatus of any of examples 50 to 51, wherein the response to the request to upload the avatar indicates that uploading the avatar was a failure, when the avatar identifier is unavailable.

Example 53. The apparatus of any of examples 16 to 52, wherein the instructions, when executed by the at least one processor, cause the apparatus at least to: receive a request to download the at least one avatar, when the apparatus stores at least one avatar identifier associated with the at least one avatar, wherein the at least one activity comprises downloading the at least one avatar; wherein the request to download the at least one avatar comprises the at least one avatar identifier; and transmit a response indicating whether downloading the at least one avatar was a success or a failure; wherein the response indicating whether downloading the at least one avatar was a success or failure comprises information related to the at least one avatar, when downloading the at least one avatar was a success.

Example 54. The apparatus of example 53, wherein: the response that indicates whether downloading the at least one avatar indicates that downloading the avatar was a failure, when the at least one avatar identifier or at least one subscriber identifier is unavailable; and the response that indicates whether downloading the at least one avatar indicates that downloading the avatar was a failure, when a user equipment or application server is not authorized for the downloading of the at least one avatar.

Example 55. The apparatus of any of examples 53 to 54, wherein the response indicating whether downloading the at least one avatar was a success or failure comprises information related to multiple avatars, when multiple avatars are linked to at least one subscriber identifier.

Example 56. The apparatus of any of examples 16 to 55, wherein the apparatus comprises one of: a network exposure function that is part of a core network, or a digital asset container that is part of a core network, or a digital asset container that is not part of a core network, or an application function that is not part of a core network, or an application server that is not part of a core network.

Example 57. The apparatus of example 56, wherein the core network comprises a fifth generation (5G) core network.

Example 58. The apparatus of any of examples 56 to 57, wherein the apparatus comprises the network exposure function when the digital asset container is within a core network and the application function is untrusted.

Example 59. The apparatus of any of examples 56 to 58, wherein the digital asset container, the application function, and the application server that are not part of the core network are part of an application layer.

Example 60. A method including: transmitting a request to perform at least one activity related to at least one avatar; and receiving a response to the request to perform the at least one activity related to the at least one avatar that indicates whether performing the at least one activity related to the at least one avatar was a success or failure.

Example 61. A method including: receiving a request to perform at least one activity related to at least one avatar; and transmitting a response to the request to perform the at least one activity related to the at least one avatar that indicates whether performing the at least one activity related to the at least one avatar was a success or failure.

Example 62. An apparatus including: means for transmitting a request to perform at least one activity related to at least one avatar; and means for receiving a response to the request to perform the at least one activity related to the at least one avatar that indicates whether performing the at least one activity related to the at least one avatar was a success or failure.

Example 63. An apparatus including: means for receiving a request to perform at least one activity related to at least one avatar; and means for transmitting a response to the request to perform the at least one activity related to the at least one avatar that indicates whether performing the at least one activity related to the at least one avatar was a success or failure.

Example 64. A computer readable medium including instructions stored thereon for performing at least the following: transmitting a request to perform at least one activity related to at least one avatar; and receiving a response to the request to perform the at least one activity related to the at least one avatar that indicates whether performing the at least one activity related to the at least one avatar was a success or failure.

Example 65. A computer readable medium including instructions stored thereon for performing at least the following: receiving a request to perform at least one activity related to at least one avatar; and transmitting a response to the request to perform the at least one activity related to the at least one avatar that indicates whether performing the at least one activity related to the at least one avatar was a success or failure.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

The term “non-transitory,” as used herein, is a limitation of the medium itself (i.e., tangible, not a signal) as opposed to a limitation on data storage persistency (e.g., RAM vs. ROM).

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):

| | |
|---|---|
| 3GPP | third generation partnership project |
| 4G | fourth generation |
| 5G | fifth generation |
| 5GC | 5G core network |
| 5GS | 5G system |
| AF | application function |
| AMF | access and mobility management function |
| API | application programming interface |
| AS | application server |
| ASIC | application-specific integrated circuit |
| CD | compact/computer disc |
| CN | core network |
| CPU | central processing unit |
| CU | central unit or centralized unit |
| DAC | digital asset container or digital assets container |
| DSP | digital signal processor |
| DU | distributed unit |
| DVD | digital versatile disc |
| EDGEAPP | edge applications |
| eNB | evolved Node B (e.g., an LTE base station) |
| EN-DC | E-UTRAN new radio-dual connectivity |
| en-gNB | node providing NR user plane and control plane protocol |
| | terminations towards the UE, and acting as a secondary node in |
| | DC |
| E-UTRA | evolved UMTS terrestrial radio access, i.e., the LTE radio access |
| | technology |
| E-UTRAN | E-UTRA network |
| F1 | interface between the CU and the DU |
| FFS | for further study |
| FPGA | field-programmable gate array |
| gNB | generalized node B, base station for 5G/NR, i.e., a node providing |
| | NR user plane and control plane protocol terminations towards the |
| | UE, and connected via the NG interface to the 5GC |
| GPSI | generic public subscription identifier |
| IAB | integrated access and backhaul |
| ID | identifier |
| I/F | interface |
| I/O | input/output |
| LMF | location management function |
| LTE | long term evolution (4G) |
| MAC | medium access control |
| MME | mobility management entity |
| MNO | mobile network operator |
| MRO | mobility robustness optimization |
| NCE | network control element |
| NEF | network exposure function |
| ng or NG | new generation |
| ng-eNB | new generation eNB |
| NG-RAN | new generation radio access network |
| NR | new radio |
| N/W | network |
| PDA | personal digital assistant |
| PDCP | packet data convergence protocol |
| PHY | physical layer |
| QoS | quality of service |
| RAM | random access memory |
| RAN | radio access network |
| Rel | release |
| RLC | radio link control |
| ROM | read-only memory |
| RRC | radio resource control |
| RU | radio unit |
| Rx | receive, or receiver, or reception |
| SA | system aspects (e.g. SA2) |
| SDAP | service data adaptation protocol |
| SEAL | service enabler architecture layer as specified in 3GPP TS 23.434 |
| SFTP | secure file transfer protocol |
| SGW | serving gateway |
| SMF | session management function |
| SON | self-organizing/optimizing network |
| TRP | transmission reception point |
| TS | technical specification |
| Tx | transmit, or transmitter, or transmission |
| UAV | unmanned aerial vehicle |
| UE | user equipment (e.g., a wireless, typically mobile device) |
| UI | user interface |
| UMTS | Universal Mobile Telecommunications System |
| UPF | user plane function |
| URI | uniform resource identifier |
| USB | universal serial bus |
| X2 | network interface between RAN nodes and between RAN and the |
| | core network |
| Xn | network interface between NG-RAN nodes |
| XR | extended reality |

1. An apparatus comprising:
at least one processor; and
at least one memory storing instructions that, when executed by the at least one processor, cause the apparatus at least to:
transmit a request to perform at least one activity related to at least one avatar; and
receive a response to the request to perform the at least one activity related to the at least one avatar that indicates whether performing the at least one activity related to the at least one avatar was a success or failure.

2. The apparatus of claim 1, wherein the instructions, when executed by the at least one processor, cause the apparatus at least to:
transmit a request to create at least one avatar profile for the at least one avatar, wherein the at least one activity comprises creating the at least one avatar profile for the at least one avatar; and
receive a response to the request to create the at least one avatar profile for the at least one avatar that indicates whether creating the at least one avatar profile for the at least one avatar was a success or failure;
wherein when creating the at least one avatar profile for the at least one avatar was a success, the response includes at least one avatar identifier;
wherein when creating the at least one avatar profile for the at least one avatar was a failure, the response to the request to create the at least one avatar profile for the at least one avatar includes a reason for the failure.

3. The apparatus of claim 2, wherein the request to create the at least one avatar profile comprises at least one or more of:
the at least one avatar identifier, or
avatar properties including at least one avatar name and a maximum size of the at least one avatar, or
usage policies for the at least one avatar, wherein a usage policy for the at least one avatar comprises an application sever identity and usage criteria, wherein the usage criteria comprise a location, time, or date applicable to the at least one avatar.

4. The apparatus of claim 1, wherein the instructions, when executed by the at least one processor, cause the apparatus at least to:
transmit a request to upload the at least one avatar, wherein the at least one activity comprises uploading the at least one avatar;
wherein the request to upload the at least one avatar comprises at least one or more of: at least one avatar identifier, or avatar object or media information comprising a media file or a uniform resource identifier where media associated with the at least one avatar resides; and
receive a response to the request to upload the at least one avatar that indicates whether uploading the at least one avatar was a success or failure.

5. The apparatus of claim 1, wherein the instructions, when executed by the at least one processor, cause the apparatus at least to:
transmit a request to download the at least one avatar, wherein the at least one activity comprises downloading the at least one avatar;
wherein the request to download the at least one avatar comprises at least one avatar identifier, at least one subscriber identifier, and filter or adaptation information;
wherein the filter or adaptation information comprises at least one or more of: a server, media adaptation information related to the server comprising compression or resolution of media, or media adaptation information related to a user equipment comprising network quality of service information related to compression or resolution of media; and
receive a response to the request to download the at least one avatar that indicates whether downloading the at least one avatar was a success or failure; and
receive information related to the at least one avatar, when downloading the at least one avatar was a success, wherein the information related to the at least one avatar comprises adapted avatar information that is adapted based on the filter or adaptation information.

6. The apparatus of claim 1, wherein the instructions, when executed by the at least one processor, cause the apparatus at least to:
transmit a request to modify the at least one avatar, wherein the at least one activity comprises modifying the at least one avatar;
wherein the request to modify the at least one avatar comprises at least one avatar identifier, information related to the at least one avatar, and avatar properties; and
receive a response to the request to modify the at least one avatar;
wherein the response to the request to modify the at least one avatar indicates whether modifying the at least one avatar was a success or a failure;
wherein the response to the request to modify the at least one avatar indicates that modifying the at least avatar is a failure when the at least one avatar identifier is unavailable.

7. The apparatus of claim 1, wherein the instructions, when executed by the at least one processor, cause the apparatus at least to:
transmit a request to delete the at least one avatar, wherein the at least one activity comprises deleting the at least one avatar;
wherein the request to delete the at least one avatar comprises at least one of: a list of at least one avatar identifier, or at least one subscriber identifier; and
receive a response to the request to delete the at least one avatar;
wherein the response to the request to delete the at least one avatar indicates whether deleting the at least one avatar was a success or a failure;
wherein the response to the request to delete the at least one avatar includes the at least one avatar identifier that is deleted when the response to the request to delete the at least one avatar indicates success;
wherein the response to the request to delete the at least one avatar indicates that deleting the at least one avatar is a failure, when the apparatus is not authorized to delete the at least one avatar.

8. The apparatus of claim 1, wherein the apparatus comprises an application server or a user equipment.

9. An apparatus comprising:
at least one processor; and
at least one memory storing instructions that, when executed by the at least one processor, cause the apparatus at least to:
receive a request to perform at least one activity related to at least one avatar; and
transmit a response to the request to perform the at least one activity related to the at least one avatar that indicates whether performing the at least one activity related to the at least one avatar was a success or failure.

10. The apparatus of claim 9, wherein the instructions, when executed by the at least one processor, cause the apparatus at least to:
receive a request to create at least one avatar profile for the at least one avatar, wherein the at least one activity comprises creating the at least one avatar profile for the at least one avatar; and
transmit a response to the request to create the at least one avatar profile for the at least one avatar that indicates whether creating the at least one avatar profile for the at least one avatar was a success or failure;
wherein when creating the at least one avatar profile for the at least one avatar was a success, the response includes at least one avatar identifier;
wherein when creating the at least one avatar profile for the at least one avatar was a failure, the response to the request to create the at least one avatar profile for the avatar includes a reason for the failure.

11. The apparatus of claim 10, wherein the request to create the at least one avatar profile comprises at least one or more of:
the at least one avatar identifier, or
avatar properties including at least one avatar name and a maximum size of the at least one avatar, or
usage policies for the at least one avatar, wherein a usage policy for the at least one avatar comprises an application sever identity and usage criteria, wherein the usage criteria comprise a location, time, or date applicable to the at least one avatar.

12. The apparatus of claim 9, wherein the instructions, when executed by the at least one processor, cause the apparatus at least to:
receive a request to upload the at least one avatar, wherein the at least one activity comprises uploading the at least one avatar;
wherein the request to upload the at least one avatar comprises at least one or more of: at least one avatar identifier, or avatar object or media information comprising a media file or a uniform resource identifier where media associated with the at least one avatar resides; and
transmit a response to the request to upload the at least one avatar that indicates whether uploading the at least one avatar was a success or failure.

13. The apparatus of claim 9, wherein the instructions, when executed by the at least one processor, cause the apparatus at least to:
receive a request to download the at least one avatar, wherein the at least one activity comprises downloading the at least one avatar;
wherein the request to download the at least one avatar comprises at least one avatar identifier, at least one subscriber identifier, and filter or adaptation information;
wherein the filter or adaptation information comprises at least one or more of: a server, media adaptation information related to the server comprising compression or resolution of media, or media adaptation information related to a user equipment comprising network quality of service information related to compression or resolution of media;
transmit a response to the request to download the at least one avatar that indicates whether downloading the at least one avatar was a success or failure; and
transmit information related to the at least one avatar, when downloading the at least one avatar was a success.

14. The apparatus of claim 9, wherein the instructions, when executed by the at least one processor, cause the apparatus at least to:
receive a request to modify the at least one avatar, wherein the at least one activity comprising modifying the at least one avatar;
wherein the request to modify the at least one avatar comprises at least one avatar identifier, information related to the at least one avatar, and avatar properties; and
transmit a response to the request to modify the at least one avatar;
wherein the response to the request to modify the at least one avatar indicates whether modifying the at least one avatar was a success or a failure;
wherein the response to the request to modify the at least one avatar indicates failure when the at least one avatar identifier is unavailable.

15. The apparatus of claim 9, wherein the instructions, when executed by the at least one processor, cause the apparatus at least to:
receive a request to delete the at least one avatar, wherein the at least one activity comprises deleting the at least one avatar;
wherein the request to delete the at least one avatar comprises at least one of: a list of at least one avatar identifier, or at least one subscriber identifier; and
transmit a response to the request to delete the at least one avatar;
wherein the response to the request to delete the at least one avatar indicates whether deleting the at least one avatar was a success or a failure;
wherein the response to the request to delete the at least one avatar includes the at least one avatar identifier that is deleted when the response to the request to delete the at least one avatar indicates that deleting the at least one avatar is a success;
wherein the response to the request to delete the at least one avatar indicates that deleting the at least one avatar is a failure, when an application server or user equipment from which the request to delete the at least one avatar was received is not authorized to delete the at least one avatar.

16. The apparatus of claim 9, wherein the instructions, when executed by the at least one processor, cause the apparatus at least to:
create information associated with at least one avatar profile of the at least one avatar, wherein the information associated with the at least one avatar profile includes at least one avatar identifier.

17. The apparatus of claim 9, wherein the instructions, when executed by the at least one processor, cause the apparatus at least to:
receive a request to upload the at least one avatar, wherein the at least one activity comprises uploading the at least one avatar;
determine whether the apparatus stores at least one avatar identifier associated with the at least one avatar;
store object or media information associated with the at least one avatar, in response to the apparatus storing the at least one avatar identifier; and
transmit a response to the request to upload the at least one avatar, wherein the response to the request to upload the avatar indicates whether uploading the avatar was a success or failure.

18. The apparatus of claim 9, wherein the instructions, when executed by the at least one processor, cause the apparatus at least to:
receive a request to download the at least one avatar, when the apparatus stores at least one avatar identifier associated with the at least one avatar, wherein the at least one activity comprises downloading the at least one avatar;
wherein the request to download the at least one avatar comprises the at least one avatar identifier; and
transmit a response indicating whether downloading the at least one avatar was a success or a failure;
wherein the response indicating whether downloading the at least one avatar was a success or failure comprises information related to the at least one avatar, when downloading the at least one avatar was a success.

19. The apparatus of claim 9, wherein the apparatus comprises one of:
a network exposure function that is part of a core network, or
a digital asset container that is part of a core network, or
a digital asset container that is not part of a core network, or
an application function that is not part of a core network, or
an application server that is not part of a core network.
wherein the core network comprises a fifth generation (5G) core network.
wherein the apparatus comprises the network exposure function when the digital asset container is within a core network and the application function is untrusted.
wherein the digital asset container, the application function, and the application server that are not part of the core network are part of an application layer.

20. A method for communications, the method comprising:
transmitting a request to perform at least one activity related to at least one avatar; and
receiving a response to the request to perform the at least one activity related to the at least one avatar that indicates whether performing the at least one activity related to the at least one avatar was a success or failure.
